(19) United States
(12) Patent Application Publication
(10) Pub. No.: US 2002/0171734 A1
(43) Pub. Date: Nov. 21, 2002

(54) Remote monitoring system

(76) Inventors: Hiroshi Arakawa, Kyoto (JP); Tomoaki Itoh, Kanagawa (JP); Junichi Sato, Nara (JP); Takao Yamaguchi, Tokyo (JP)

Correspondence Address: HARNESS, DICKEY & PIERCE, P.L.C., P.O. BOX 828, BLOOMFIELD HILLS, MI, 48303, US

(21) Appl. No.: 10/146,189

(22) Filed: May 15, 2002

(30) Foreign Application Priority Data
May 16, 2001 (JP) 2001-146,196

(51) Int. Cl. H04N 7/18

(52) U.S. Cl. 348/143; 348/152

(57) ABSTRACT

Cameras respectively installed at a plurality of homes and a monitoring center of a security service provider for centralized monitoring are connected together via a network. Each camera, which has a programmable internal module configuration, acquires from a module control center a program module for executing, based on video data about a target for monitoring, a recognition process for detection of the occurrence of abnormal events to the monitored target, and link information about the program module, as required.

### BACKGROUND OF THE INVENTION

The present invention relates to a remote monitoring system making use of a monitoring camera.

Japanese Patent Kokai Publication Gazette No. H11-112674 discloses a remote monitoring system making utilization of a communications line. According to the remote monitoring system, a computer installed at a location to be monitored, and another computer installed on the side of a central monitoring station are connected together via the communications line. Besides, in order to increase the efficiency of monitoring operations, and in order to provide a surveillant with immediate verification of the occurrence of abnormal events, it is arranged such that an abnormal condition, if occurs to a target for monitoring, is detected at the monitored location based on the interframe differences of video signals acquired by the monitoring camera, and compression-coded video data are transmitted to the surveillant, only at the time of detection of the occurrence of abnormal events.

However, this conventional technique has the disadvantage of not being able to change an abnormality detection algorithm, depending on the type of target for monitoring. For example, for the case of housebreaker monitoring, it is necessary to change the abnormality detection algorithm depending on the camera installation location. For example, a camera installed at the front door having many visitors and a camera installed by a window require different abnormality detection algorithms. Further, the object recognition function of cameras depends largely on the lighting condition. For the case of expressway traffic jam monitoring, it is desirable to be able to change the abnormality detection algorithm, depending on the weather as well as on the hour.

### SUMMARY OF THE INVENTION

Accordingly, an object of the present invention is to make it possible to change, without difficulties, an abnormality detection algorithm of a remote monitoring system making use of a monitoring camera.

In order to achieve the object, the present invention is characterized by a monitoring camera (i.e., an image acquisition means) for acquiring images of a target for monitoring, and the image acquisition means comprises: a transmitting part for transmitting video data about the monitored target: a receiving part for receiving function change information; and a module control part for changing, according to the function change information, a programmable internal module configuration. The function change information includes information which specifies a program module for realizing a function of the image acquisition means, and link information about the program module.

### BRIEF DESCRIPTION OF THE DRAWINGS

FIG. 1 is a conceptual diagram showing an arrangement of a remote monitoring system of the present invention.

FIG. 2 is a block diagram showing an example of an initial module configuration of a camera shown in FIG. 1.

FIG. 3 is a block diagram showing a module configuration updated of a camera shown in FIG. 2.

FIG. 4 is a conceptual diagram showing an example of function change information that the camera of FIG. 2 receives from a module control center.

### DETAILED DESCRIPTION OF THE INVENTION

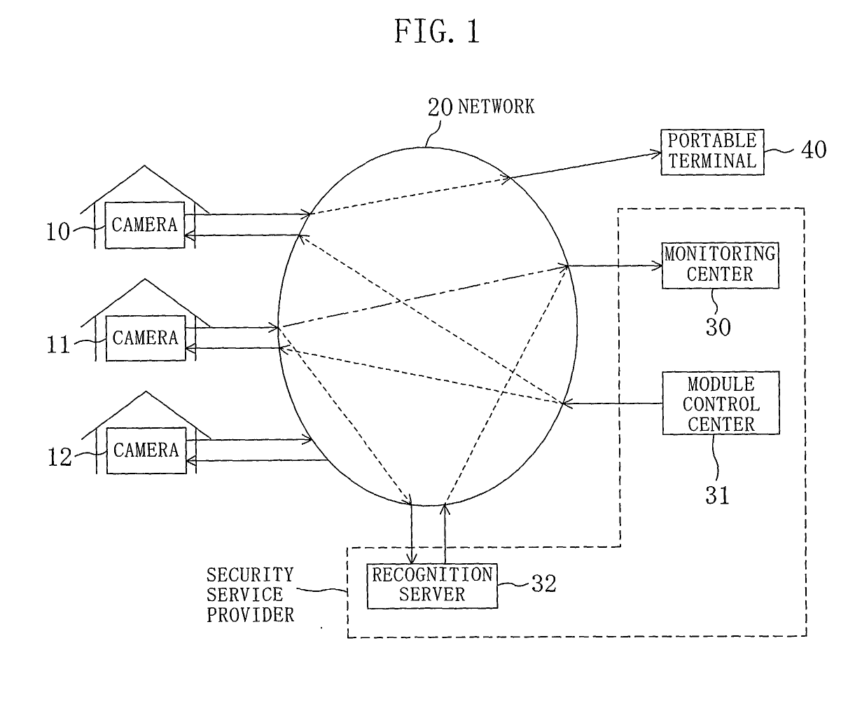

Referring first to FIG. 1, there is shown an exemplary arrangement of a remote monitoring system relating to the present invention. This remote monitoring system is based on the condition that a security service provider (hereinafter SSP) provides security services (e.g., housebreaker monitoring, fire alarming and so on) to a plurality of homes under contract therewith. More specifically, monitoring cameras 10, 11, and 12 installed at the respective homes and a monitoring center 30 of the SSP for centralized monitoring are connected together via a network 20. The network 20 comprises for example public lines. Each camera 10, 11, and 12 has, in addition to a function of acquiring images of a target for monitoring, a function of transmitting video data and a function of receiving information sent from the SSP. In the Figure, two lines are drawn between each camera 10, 11, and 12 and the network 20, but these two lines are shown just to indicate the fact that data will flow in both directions, for the sake of descriptive convenience. In practice, each camera 10, 11, and 12 and the network 20 are physically connected together via a single cable. The monitoring center 30 is equipped with a system by which video data received are displayed on a monitor screen so that a surveillant can perform monitoring work. In the system of FIG. 1, a user who is a resident in a home equipped with the particular camera 10 is allowed to receive video data about his/her home by establishing connection between his/her portable terminal 40 and the network 20.

The cameras 10, 11, and 12 of FIG. 1 have programmable internal module configurations, respectively, and these internal module configurations are changeable according to function change information transmitted from a module control center 31 of the SSP. And the internal module configuration of each camera 10, 11, and 12 is determined on a contract basis between each user and the SSP. Further, in the system of FIG. 1, a recognition server 32 of the SSP is also connected to the network 20. The recognition server 32 is a processor having a function of executing, based on video data about a target for monitoring transmitted from any of the cameras 10, 11, and 12, a recognition process for detection of the occurrence of abnormal events to the monitored target.

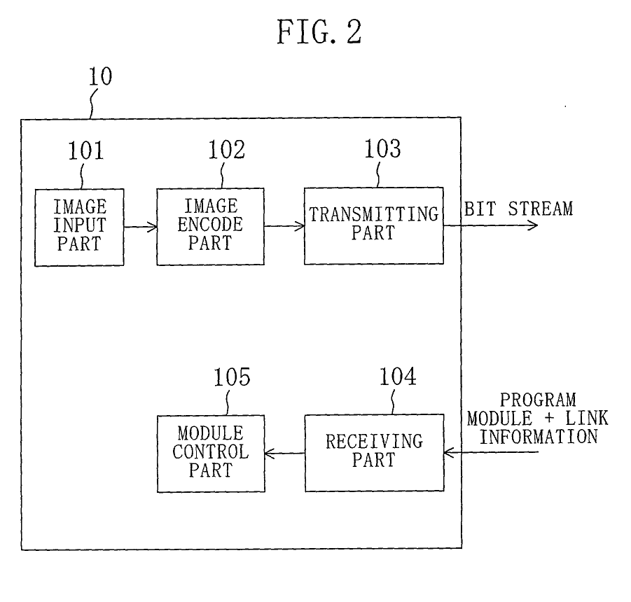

Referring now to FIG. 2, there is shown an example of an initial module configuration of the camera 10 of FIG. 1. The other cameras 11 and 12 of FIG. 1 have the same initial module configuration as that of the camera 10. The camera 10 of FIG. 2 has a programmable module configuration comprising, as its basic hardware, a CCD (Charge Coupled Device) image pickup device, an image processor, and a modem. FIG. 2 represents a hardware/software configuration of the camera 10 in the form of a functional block diagram. Mounted between modules constituting the camera 10 is an IPC (InterProcess Communication) that is equivalent to a buffer memory for data exchange.

The camera 10 of FIG. 2 has an initial module configuration comprising an image input part 101, an image encode part 102, a transmitting part 103, a receiving part 104, and a module control part 105. The image input part 101 is a module comprising a CCD image pickup device as a core element and outputs a video signal of an NTSC (National Television Standards Committee) format. The image encode part 102 receives the video signal from the image input part 101 and compression encodes it by using for example an MPEG (Moving Picture Coding Experts Group) technique, to generate a bit stream which is video data. The transmitting part 103 receives the bit stream from the image encode part 102 for transmitting to the network 20. For example, a protocol called UDP (User Datagram Protocol) of the TCP (Transmission Control Protocol)/IP (Internet Protocol) is available. A known payload format for MPEG1 transmission may be used for video data packetization (D. Hoffman et al., “RTP Payload Format for MPEG1/MPEG2 Video”, RFC 2250, Internet Engineering Taskforce, January 1998).

The receiving part 104 of FIG. 2 is a module for receiving function change information transmitted from the module control center 31. The function change information contains information which specifies a program module for realizing a function of the camera 10, and link information about the program module. The link information is information indicative of connecting relationships of the input and the output of the program module. The link information describes not only an intermodule connecting relationship within the camera 10 but also an intermodule connecting relationship via the network 20. The module control part 105 is a module for changing a programmable internal module configuration according to function change information and has a function of establishing connection between a program module received and the existing program module and a function of activating such program modules.

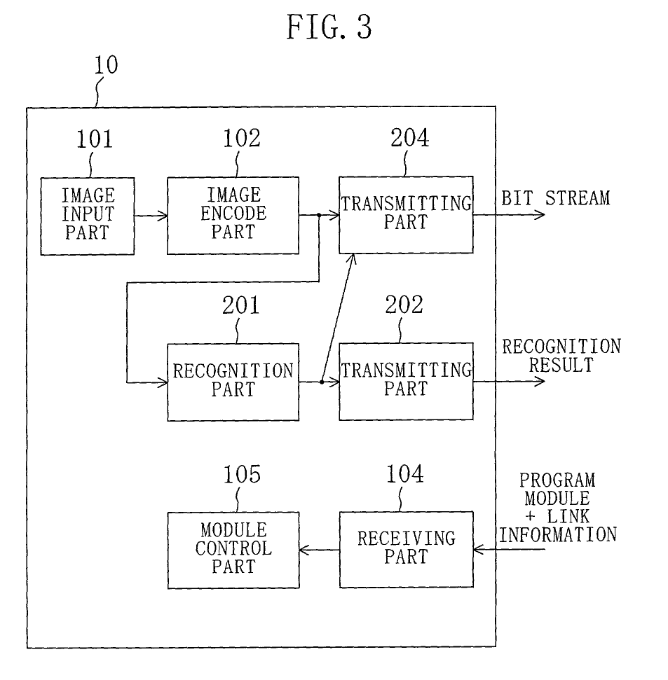

Referring now to FIG. 3, there is shown a module configuration updated of the camera 10 of FIG. 2. Here, a recognition part 201 and a first transmitting part 202 are added, and the transmitting part 103 is replaced by a second transmitting part 204. This will be described in greater detail. The receiving part 104 first receives information specifying a program module of the recognition part 201, and link information indicating that an input to the recognition part 201 is an output from the image encode part 102. Subsequently, the receiving part 104 receives information specifying a program module of the first transmitting part 202, and link information indicating that an input to the first transmitting part 202 is an output from the recognition part 201. The receiving part 104 further receives information specifying a program module of the second transmitting part 204 as a substitute of the original transmitting part 103, and information indicating that inputs to the second transmitting part 204 are outputs from the image encode part 102 and from the recognition part 201, respectively. The module control part 105 establishes connection between each module according to these information pieces received.

The recognition part 201 of FIG. 3 is a module capable of executing, based on video data about the monitored target, a recognition process for detection of the occurrence of abnormal events to the monitored target. For example, the recognition part 201 extracts a motion vector from a bit stream generated in the image encode part 102, and if there is an excessive movement in a local area, the recognition part 201 outputs VALUE 1 indicative of detection of a moving object in the local area, otherwise VALUE 0 is output. Further, the degree of similarity between a color within the local area and the color of human skin is found and is output in combination with a moving object detection, as a vector.

The first transmitting part 202 is a module for transmitting to the network 20 a result of the recognition process executed by the recognition part 201. If, in addition to images of the monitored target, the recognition process result is presented to the surveillant at the monitoring center 30, this allows the surveillant to acquire guide information about the object to be watched carefully. This therefore makes it possible to reduce the labor of the surveillant.

The second transmitting part 204 is a module for transmitting, after reducing video data about the monitored target received from the image encode part 102, it to the network 20, during the time that no occurrence of an abnormal event to the monitored target is detected. For example, at the time of detection of a moving object (VALUE 1) as described above, all the bit streams including a P (Predictive) picture and a B (Bidirectionally predictive) picture are transmitted without reduction, while at the time of non-detection of a moving object (VALUE 0) only a bit stream corresponding to an I (Intra) picture is transmitted. Stated another way, there is made a distinction between an abnormal condition and a normal condition, and if an abnormal condition is detected, then video data are transmitted at a high frame rate, whereas if a normal condition is detected, then video data are transmitted at a low frame rate. This arrangement makes it possible to reduce the amount of transmitting video data in the normal condition while maintaining the frame rate in the abnormal condition. Alternatively, an arrangement, which distinguishes between the use of high resolution in an abnormal condition and the use of low resolution in a normal condition, may be made. Further, there is a certain time delay in the output of the recognition part 201, because of which the second transmitting part 204 buffers the bit streams until the time it receives an output from the recognition part 201 corresponding to a particular image frame.

The functions of the recognition part 201, the first transmitting part 202, and the second transmitting part 204 (FIG. 3) may be transferred to the recognition server 32 (FIG. 1). Here, the camera 11 of FIG. 1, while maintaining its initial module configuration (FIG. 2), changes a destination to which bit streams are sent, from the monitoring center 30 to the recognition server 32 according to function change information sent from the module control center 31. This also provides the same effects as those achieved by the camera 10 having an updated module configuration of FIG. 3. The single recognition server 32 may be time-shared between the plural cameras 10, 11, and 12.

As has been described above, the remote monitoring system (FIG. 1) makes it possible to freely change an abnormality detection algorithm in the recognition part 201, depending upon the place where the monitoring cameras 10, 11, and 12 are installed and their lighting condition. Further, even when there is made a change in the contract between a user and the SSP from “NOT REQUIRING ABNORMALITY DETECTION SERVICE” to “REQUIRING ABNORMALITY DETECTION SERVICE”, it is possible to send a program module of the recognition part 201 to the camera 10. Furthermore, the remote monitoring system of FIG. 1 is able to easily deal with such a case that, despite the development of a new abnormality detection algorithm, video data are still transferred intact to the recognition server 32 because the load is too high for the processing capabilities of older cameras.

Further, it may be arranged such that the recognition server 32 is provided with a module control part 105 as shown in FIG. 2 and changes an internal module configuration according to function change information sent from the module control center 31. Furthermore, it may be arranged such that each camera 10, 11, and 12 and the recognition server 32 share a part of a recognition process for detection of the occurrence of abnormal events to the monitored target.

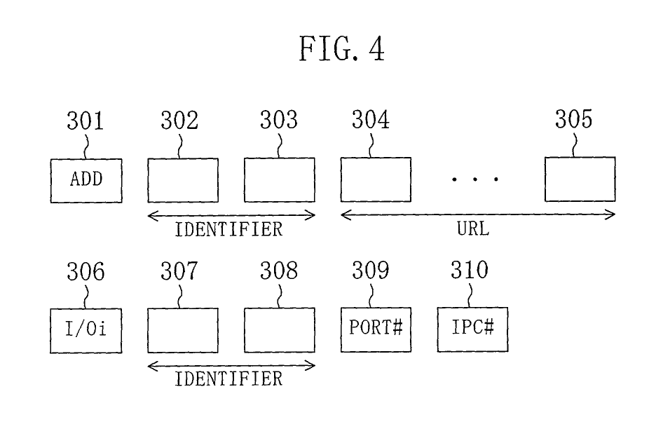

Finally, an example of a transmission format of the function change information will be described. Referring to FIG. 4, there is shown an example of function change information that the camera 10 of FIG. 2 receives from the module control center 31, more specifically information specifying a program module of the recognition part 201 and link information indicating that an input to the recognition part 201 is an output from the image encode part 102. Elements 301-310 each represent one byte. These bytes, when arranged in an ascending order of these reference numbers, are a transfer format. There exist bytes (not shown in the Figure) between the bytes 304 and 305.

301 of FIG. 4 is a byte representing a module addition command and is followed by the two bytes 302 and 303 representing an identifier and then by the bytes 304 and 305 representing a variable-length character string. The recognition part 201 is specified by the identifiers 302 and 303 and the subsequent character string specifies an URL (Uniform Resource Locator) for acquiring a program module of the recognition part 201. 305 is a byte comprised only of bits of 0 value and specifying the end of the character string. The receiving part 104 has a function of acquiring, based on an URL specified, an entity of a program module to be added. 306 is a byte representing a command relating to input link information (I/Oi). The module control part 105 is operable to bring an IPC specified by 310 into link with an input port (i.e., an input port having a port number specified by 309) of a module specified by the identifiers 307 and 308 (i.e., the recognition part 201). This IPC in this case is an IPC on the output side of the image encode part 102.

Further, module deletion commands, module replacement commands, commands relating to output link information, and so forth may be used. Arguments at the time of activation of each program module may be included in function change information. Further, without making utilization of URL a program module entity may be included in the aforementioned transmission format. It may be arranged such that the module control center 31 prepares, in the form of a time table, function change information to be transmitted in order. It may be arranged such that the transmission or receiving history of information transmitted between each camera 10, 11, and 12 and the recognition server 32, and the module control center 31 is stored for future utilization.

What is claimed is:

1. A remote monitoring system implemented by connecting, via a communications line, image acquisition means for acquiring images of a target for monitoring and a system installed on the side of a central monitoring station,
said image acquisition means comprising:
a transmitting part for transmitting video data about said monitored target,
a receiving part for receiving function change information, and
a module control part for changing, according to said function change information, a programmable internal module configuration.

2. The remote monitoring system of claim 1, wherein said function change information includes information which specifies a program module for realizing a function of said image acquisition means, and link information about said program module.

3. The remote monitoring system of claim 2, wherein said program module includes a module which executes, based on said video data about said monitored target, a recognition process for detection of the occurrence of abnormal events to said monitored target.

4. The remote monitoring system of claim 3, wherein said image acquisition means has, in addition to said function of transmitting said video data about said monitored target, a function of transmitting a result of said recognition process.

5. The remote monitoring system of claim 3, wherein said image acquisition means has a function of transmitting, after reducing said video data about said monitored target, it during the time that no occurrence of an abnormal event to said monitored target is detected.

6. The remote monitoring system of claim 1 further comprising:
a recognition system connected to said communications line,
wherein said recognition system has a function of executing, based on said video data about said monitored target sent from said image acquisition means, a recognition process for detection of the occurrence of abnormal events to said monitored target.

7. The remote monitoring system of claim 6, wherein said recognition system has, in addition to said function of transmitting said video data about said monitored target, a function of transmitting a result of said recognition process.

8. A camera for use in a remote monitoring system for acquiring images of a target for monitoring, said camera comprising:
a transmitting part for transmitting video data about said monitored target,
a receiving part for receiving function change information, and
a module control part for changing, according to said function change information, a programmable internal module configuration.
